(19) United States
(12) Patent Application Publication
(10) Pub. No.: US 2025/0301261 A1
(43) Pub. Date: Sep. 25, 2025

(54) SIGNAL PROCESSING METHOD, APPARATUS, DEVICE AND COMPUTER-READABLE STORAGE MEDIUM

(71) Applicant: GOERTEK TECHNOLOGY CO., LTD., Qingdao (CN)

(72) Inventors: Guangsheng LIU, Qingdao (CN); Yu Zhou, Qingdao (CN); Rongliang Xie, Qingdao (CN); Jianpeng Yin, Qingdao (CN); Ruozhou Huang, Qingdao (CN); Zongxia Zhu, Qingdao (CN); Yuping Zhao, Qingdao (CN); Jie Wu, Qingdao (CN)

(21) Appl. No.: 19/231,959

(22) Filed: Jun. 9, 2025

Related U.S. Application Data
(63) Continuation of application No. PCT/CN2024/094130, filed on May 20, 2024.

(30) Foreign Application Priority Data
Jul. 28, 2023 (CN) 202310945906.X

(51) Int. Cl. H04R 3/08

(52) U.S. Cl. CPC H04R 3/08; H04R 2430/01; H04R 2430/03

(57) ABSTRACT

A signal processing method, a signal processing apparatus, a signal processing device and a computer-readable storage medium are provided. The method includes: obtaining an input audio signal input to a speaker, and dividing the input audio signal into a high-frequency signal and a low-frequency signal according to a preset frequency; determining an estimated amplitude generated by the speaker based on the low-frequency signal, and determining a signal gain of the high-frequency signal based on the estimated amplitude, a gain value of the signal gain being positively correlated with the estimated amplitude; and processing, via the signal gain, a signal voltage of the high-frequency signal to obtain a processed high-frequency signal, and superimposing the processed high-frequency signal and the low-frequency signal to obtain an audio signal with suppressed intermodulation distortion.

### CROSS-REFERENCE TO RELATED APPLICATIONS

This application is a continuation application of International Application No. PCT/CN2024/094130, filed on May 20, 2024, which claims priority to Chinese Patent Application No. 202310945906.X, filed on Jul. 28, 2023. The disclosures of the above-mentioned applications are incorporated herein by reference in their entireties.

### TECHNICAL FIELD

The present application relates to the technical field of loudspeakers, and in particular to a signal processing method, a signal processing apparatus, a signal processing device and a computer-readable storage medium.

### BACKGROUND

When audio signals of at least two different frequencies are input to the speaker simultaneously, the low-frequency signal in the audio signal will push the speaker to undergo a large displacement movement, causing the nonlinear parameters of the speaker, such as the electromechanical coefficient BL(x), inductance Le(x) and other parameters to change accordingly, and the change period of the nonlinear parameters is consistent with the signal period of the low-frequency signal. The signal period of the high-frequency signal in the audio signal is smaller than the signal period of the low-frequency signal. Therefore, the process of the high-frequency signal pushing the speaker can be regarded as a quasi-static process.

However, due to the change of nonlinear parameters caused by the low-frequency signal, the Ampere driving force of the high-frequency signal changes, causing the high-frequency signal to fluctuate with the same period as the low-frequency signal. That is, the high-frequency signal generates an undesirable periodic envelope, which occurs in the entire high-frequency band, resulting in the audio signal being rough and having low purity when playing. This process is the modulation distortion of the low-frequency signal on the high-frequency signal, which is also called intermodulation distortion.

### SUMMARY

The main objective of the present application is to provide a signal processing method, a signal processing apparatus, a signal processing device and a computer-readable storage medium, aiming to suppress the intermodulation distortion of audio signals and improve the purity of sound signals.

In order to achieve the above objective, the present application provides a signal processing method, including:
obtaining an input audio signal input to a speaker, and dividing the input audio signal into a high-frequency signal and a low-frequency signal according to a preset frequency;
determining an estimated amplitude generated by the speaker based on the low-frequency signal, and determining a signal gain of the high-frequency signal based on the estimated amplitude, a gain value of the signal gain being positively correlated with the estimated amplitude; and
processing, via the signal gain, a signal voltage of the high-frequency signal to obtain a processed high-frequency signal, and superimposing the processed high-frequency signal and the low-frequency signal to obtain an audio signal with suppressed intermodulation distortion.

In an embodiment, the determining the signal gain of the high-frequency signal based on the estimated amplitude includes:
determining a nonlinear parameter change corresponding to the estimated amplitude based on the estimated amplitude and a nonlinear characteristic curve of the speaker; and
determining the signal gain of the high-frequency signal based on the nonlinear parameter change.

In an embodiment, the nonlinear characteristic curve includes an electromechanical coefficient curve, and
the determining the nonlinear parameter change corresponding to the estimated amplitude based on the estimated amplitude and the nonlinear characteristic curve of the speaker includes:
determining electromechanical coefficient attenuation of a voice coil position corresponding to the estimated amplitude relative to an equilibrium position based on the estimated amplitude and the electromechanical coefficient curve; and
taking the electromechanical coefficient attenuation as the nonlinear parameter change corresponding to the estimated amplitude.

In an embodiment, the determining the estimated amplitude generated by the speaker based on the low-frequency signal includes:
obtaining a linear parameter of the speaker and a nonlinear parameter of the speaker; and
calculating, based on the linear parameter, the nonlinear parameter and a preset state equation, the estimated amplitude generated by the speaker based on the low-frequency signal.

In an embodiment, the obtaining the linear parameter of the speaker and the nonlinear parameter of the speaker includes:
obtaining current and voltage signals of the speaker;
performing system identification on the current and voltage signals to obtain an identification linear parameter and an identification nonlinear parameter; and
taking the identification linear parameter as the linear parameter, and taking the identification nonlinear parameter as the nonlinear parameter.

In an embodiment, before the dividing the input audio signal into the high-frequency signal and the low-frequency signal according to the preset frequency, the method further includes:
determining a signal frequency response curve of the input audio signal, and determining a reference amplitude based on an amplitude corresponding to a starting frequency point in the signal frequency response curve; and
determining a reference frequency corresponding to the reference amplitude in the signal frequency response curve, and determining the preset frequency based on the reference frequency.

In an embodiment, the determining the preset frequency based on the reference frequency includes:
in response to that the reference frequency is less than or equal to a preset frequency threshold, taking the reference frequency as the preset frequency; or
in response to that the reference frequency is greater than the preset frequency threshold, taking the frequency threshold as the preset frequency.

In order to achieve the above objective, the present application further provides a signal processing apparatus, including:
an obtaining module, configured for obtaining an input audio signal input to a speaker, and dividing the input audio signal into a high-frequency signal and a low-frequency signal according to a preset frequency;
a determination module, configured for determining an estimated amplitude generated by the speaker based on the low-frequency signal, and determining a signal gain of the high-frequency signal based on the estimated amplitude, a gain value of the signal gain being positively correlated with the estimated amplitude; and
a processing module, configured for processing, via the signal gain, a signal voltage of the high-frequency signal to obtain a processed high-frequency signal, and superimposing the processed high-frequency signal and the low-frequency signal to obtain an audio signal with suppressed intermodulation distortion.

In order to achieve the above objective, the present application further provides a signal processing device, including: a memory, a processor, and a signal processing program stored in the memory and executable on the processor, wherein the signal processing program implements the signal processing method as described above when executed by the processor.

In order to achieve the above objective, the present application further provides a computer-readable storage medium, a signal processing program is stored in the non-transitory computer-readable storage medium, and when the signal processing program is executed by a processor, the signal processing method as describe above is implemented.

The present application provides a signal processing method, including: obtaining an input audio signal input to a speaker, and dividing the input audio signal into a high-frequency signal and a low-frequency signal according to a preset frequency; determining an estimated amplitude generated by the speaker based on the low-frequency signal, and determining a signal gain of the high-frequency signal based on the estimated amplitude, a gain value of the signal gain being positively correlated with the estimated amplitude; and processing, via the signal gain, a signal voltage of the high-frequency signal to obtain a processed high-frequency signal, and superimposing the processed high-frequency signal and the low-frequency signal to obtain an audio signal with suppressed intermodulation distortion.

The larger the estimated amplitude generated by the speaker based on the low-frequency signal, the larger the change in the nonlinear parameters in the speaker, resulting in a larger change in the Ampere driving force of the high-frequency signal. In the present application, the gain value of the signal gain is positively correlated with the estimated amplitude, the larger the estimated amplitude, the larger the signal gain value of the high-frequency signal, that is, the greater the adjustment degree of the signal voltage of the high-frequency signal, so that the change in the signal voltage of the high-frequency signal can offset the change in the Ampere driving force caused by the nonlinear parameters, so that the Ampere driving force of the high-frequency signal after processing under different estimated amplitudes remains stable, and the undesired envelope generated by the intermodulation of the low-frequency signal to the high-frequency signal is suppressed, thereby suppressing intermodulation distortion and improving the purity of the audio signal output by the speaker system.

### BRIEF DESCRIPTION OF THE DRAWINGS

FIG. 1 is a schematic structural diagram of the hardware operating environment involved in the embodiment of the present application.

FIG. 2 is a schematic flowchart of a signal processing method according to an embodiment of the present application.

FIG. 3 is a schematic flowchart of a signal processing method according to an embodiment of the present application.

FIG. 4 is a schematic flowchart of a signal processing method according to an embodiment of the present application.

FIG. 5 is a schematic flowchart of a signal processing method according to an embodiment of the present application.

FIG. 6 is a schematic flowchart of a signal processing method according to an embodiment of the present application.

FIG. 7 is a schematic flowchart of a signal processing method according to an embodiment of the present application.

FIG. 8 is a schematic flowchart of a signal processing method according to an embodiment of the present application.

FIG. 9 is a nonlinear characteristic curve of BL and displacement of a signal processing method according to an embodiment of the present application.

FIG. 10A is a nonlinear characteristic curve of Le and displacement of a signal processing method according to an embodiment of the present application.

FIG. 10B is a nonlinear characteristic curve of Le and current of a signal processing method according to an embodiment of the present application.

FIG. 11 is a schematic diagram of the system structure of a signal processing method according to an embodiment of the present application.

FIG. 12 is a schematic diagram of functional modules of a signal processing apparatus according to an embodiment of the present application.

The purpose, functional features and advantages of the present application will be further explained in conjunction with the embodiments and with reference to the accompanying drawings.

### DETAILED DESCRIPTION OF THE EMBODIMENTS

It should be understood that the specific embodiments described herein are only to explain the present application and are not intended to limit the present application.

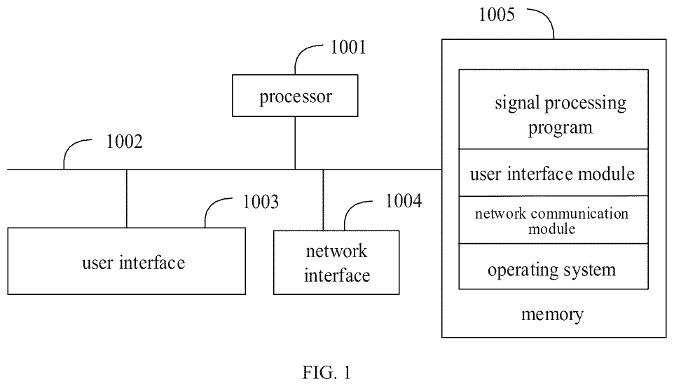

As shown in FIG. 1, FIG. 1 is a schematic diagram of the device structure of the hardware operating environment involved in the embodiment of the present application.

It should be noted that the signal processing device in the embodiment of the present application may be an audio device, such as headphones, smart glasses, head-mounted display devices, smart phones, personal computers and other devices, or a device that establishes a communication connection with an audio device, such as a server, etc., and no specific restrictions are made here.

As shown in FIG. 1, the signal processing device may include: a processor 1001, such as a CPU, a network interface 1004, a user interface 1003, a memory 1005, and a communication bus 1002. The communication bus 1002 is configured to realize the connection and communication between these components. The user interface 1003 may include a display, an input unit such as a keyboard, and the user interface 1003 may also include a standard wired interface and a wireless interface. The network interface 1004 may include a standard wired interface and a wireless interface (such as a WI-FI interface). The memory 1005 may be a high-speed RAM memory or a stable memory (non-volatile memory), such as a disk memory. The memory 1005 may also be a storage device independent of the aforementioned processor 1001.

Those skilled in the art will appreciate that the device structure shown in FIG. 1 does not constitute a limitation on the signal processing device, and may include more or fewer components than shown in the figure, or a combination of certain components, or differently arranged components.

As shown in FIG. 1, the memory 1005 as a computer storage medium may include an operating system, a network communication module, a user interface module, and a signal processing program. The operating system is a program that manages and controls the hardware and software resources of the device, and supports the operation of the signal processing program and other software or programs. In the device shown in FIG. 1, the user interface 1003 is mainly used for data communication with the client; the network interface 1004 is mainly used to establish a communication connection with the server; and the processor 1001 can call the signal processing program stored in the memory 1005 and perform the following steps:
obtaining an input audio signal input to a speaker, and dividing the input audio signal into a high-frequency signal and a low-frequency signal according to a preset frequency;
determining an estimated amplitude generated by the speaker based on the low-frequency signal, and determining a signal gain of the high-frequency signal based on the estimated amplitude, a gain value of the signal gain being positively correlated with the estimated amplitude; and
processing, via the signal gain, a signal voltage of the high-frequency signal to obtain a processed high-frequency signal, and superimposing the processed high-frequency signal and the low-frequency signal to obtain an audio signal with suppressed intermodulation distortion.

Further, the determining the signal gain of the high-frequency signal based on the estimated amplitude includes:
determining a nonlinear parameter change corresponding to the estimated amplitude based on the estimated amplitude and a nonlinear characteristic curve of the speaker; and
determining the signal gain of the high-frequency signal based on the nonlinear parameter change.

Further, the nonlinear characteristic curve includes an electromechanical coefficient curve, and
the determining the nonlinear parameter change corresponding to the estimated amplitude based on the estimated amplitude and the nonlinear characteristic curve of the speaker includes:
determining electromechanical coefficient attenuation of a voice coil position corresponding to the estimated amplitude relative to an equilibrium position based on the estimated amplitude and the electromechanical coefficient curve; and
taking the electromechanical coefficient attenuation as the nonlinear parameter change corresponding to the estimated amplitude.

Further, the determining the estimated amplitude generated by the speaker based on the low-frequency signal includes:
obtaining a linear parameter of the speaker and a nonlinear parameter of the speaker; and
calculating, based on the linear parameter, the nonlinear parameter and a preset state equation, the estimated amplitude generated by the speaker based on the low-frequency signal.

Further, the obtaining the linear parameter of the speaker and the nonlinear parameter of the speaker includes:
obtaining current and voltage signals of the speaker;
performing system identification on the current and voltage signals to obtain an identification linear parameter and an identification nonlinear parameter; and
taking the identification linear parameter as the linear parameter, and taking the identification nonlinear parameter as the nonlinear parameter.

Further, before the dividing the input audio signal into the high-frequency signal and the low-frequency signal according to the preset frequency, the processor 1001 may also call the signal processing program stored in the memory 1005 to perform the following steps:
determining a signal frequency response curve of the input audio signal, and determining a reference amplitude based on an amplitude corresponding to a starting frequency point in the signal frequency response curve; and
determining a reference frequency corresponding to the reference amplitude in the signal frequency response curve, and determining the preset frequency based on the reference frequency.

Further, the determining the preset frequency based on the reference frequency includes:
in response to that the reference frequency is less than or equal to a preset frequency threshold, taking the reference frequency as the preset frequency; or
in response to that the reference frequency is greater than the preset frequency threshold, taking the frequency threshold as the preset frequency.

Based on the above structure, various embodiments of the signal processing method are proposed.

As shown in FIG. 2, FIG. 2 is a flowchart of the signal processing method according to of an embodiment of the present application.

The embodiment of the present application provides a signal processing method. It should be noted that although the logical order is shown in the flowchart, in some cases, the steps shown or described may be performed in a different order than here. In this embodiment, the execution subject of the signal processing method may be an audio device, such as headphones, smart glasses, head-mounted display devices, smart phones, and personal computers, or a device that establishes a communication connection with the audio device, such as a server, etc., which is not limited in this embodiment. For the sake of convenience, the following description of each embodiment is omitted for the execution subject. In this embodiment, the signal processing method includes:

Step S10, obtaining an input audio signal input to a speaker, and dividing the input audio signal into a high-frequency signal and a low-frequency signal according to a preset frequency.

In this embodiment, an audio signal input to a speaker is obtained, which is hereinafter referred to as an input audio signal for distinction.

The input audio signal is divided into a high-frequency signal and a low-frequency signal according to a preset frequency, and the preset frequency can be set according to an acoustic model of the speaker or an amplitude curve of the input audio signal, or can be set according to actual needs, and is not limited here.

The speaker amplitude corresponding to the low-frequency signal is larger, and the speaker amplitude corresponding to the high-frequency signal is smaller. Intermodulation distortion is actually the modulation of the high-frequency signal by the large amplitude of the low-frequency signal, which causes the high-frequency signal to produce signal distortion caused by undesired signal fluctuations. Therefore, when dividing the high-frequency signal and the low-frequency signal, this embodiment needs to divide the high-amplitude signal into a low-frequency signal to ensure the suppression effect of intermodulation distortion.

Step S20, determining an estimated amplitude generated by the speaker based on the low-frequency signal, and determining a signal gain of the high-frequency signal based on the estimated amplitude, a gain value of the signal gain being positively correlated with the estimated amplitude.

In this embodiment, the amplitude generated by the speaker based on the low-frequency signal (hereinafter referred to as the estimated amplitude for distinction) is predicted, that is, the maximum displacement generated by the speaker based on the low-frequency signal. This embodiment does not limit the prediction method of the estimated amplitude. For example, in an embodiment, the estimated amplitude can be obtained based on the linear displacement prediction method in the nonlinear compensation algorithm. In another embodiment, the estimated amplitude can also be calculated by referring to the existing method, which is not limited herein.

In this embodiment, the signal gain of the high-frequency signal is determined based on the estimated amplitude. The signal gain is configured to compensate the voltage signal of the high-frequency signal to offset the change in the Ampere force of the high-frequency signal caused by the low-frequency signal. Since the larger the estimated amplitude generated by the speaker based on the low-frequency signal, the larger the change in the nonlinear parameters in the speaker, resulting in a larger change in the Ampere driving force of the high-frequency signal. Therefore, the estimated amplitude is set to be positively correlated with the signal gain, so that the change in the signal voltage of the high-frequency signal can offset the change in the Ampere driving force caused by the nonlinear parameters, so that the Ampere driving force of the high-frequency signal after processing under different estimated amplitudes remains stable.

In an embodiment, the parameter change of the nonlinear characteristic parameter of the loudspeaker may be determined according to the estimated amplitude, and the signal gain may be determined according to the parameter change. In another embodiment, the corresponding relationship between the amplitude and the gain may be preset, and the gain corresponding to the estimated amplitude may be determined as the signal gain according to the corresponding relationship; or the signal gain may be determined by other feasible methods, which are not limited here.

It should be noted that signal gain can be positive or negative, and the positive or negative value of signal gain is related to the Ampere driving force generated by the voice coil displacement corresponding to the estimated amplitude of the high-frequency signal. If the Ampere driving force generated by the voice coil displacement corresponding to the estimated amplitude of the high-frequency signal increases, the signal gain is negative to offset the increase in the Ampere driving force. If the Ampere driving force generated by the voice coil displacement corresponding to the estimated amplitude of the high-frequency signal decreases, the signal gain is positive to offset the attenuation of the Ampere driving force, thereby achieving the stability of the Ampere driving force.

Step S30, processing, via the signal gain, a signal voltage of the high-frequency signal to obtain a processed high-frequency signal, and superimposing the processed high-frequency signal and the low-frequency signal to obtain an audio signal with suppressed intermodulation distortion.

In this embodiment, the signal voltage of the high-frequency signal is processed by the signal gain to obtain the processed high-frequency signal. Based on the calculation formula of the Ampere force: F=iBL, it can be known that the Ampere driving force of the high-frequency signal is affected by the current i and the magnetoelectric coefficient BL. The magnetoelectric coefficient BL is determined by the estimated amplitude of the low-frequency signal. Adjusting the signal voltage can adjust the current, thereby adjusting the Ampere driving force of the high-frequency signal. In this embodiment, the processing direction of the high-frequency signal is determined by the positive or negative signal gain. When the signal gain is positive, the high-frequency signal is subjected to gain processing, that is, amplification processing; when the signal gain is negative, the high-frequency signal is subjected to attenuation processing.

The processed high-frequency signal and the low-frequency signal are superimposed to obtain an audio signal with suppressed intermodulation distortion.

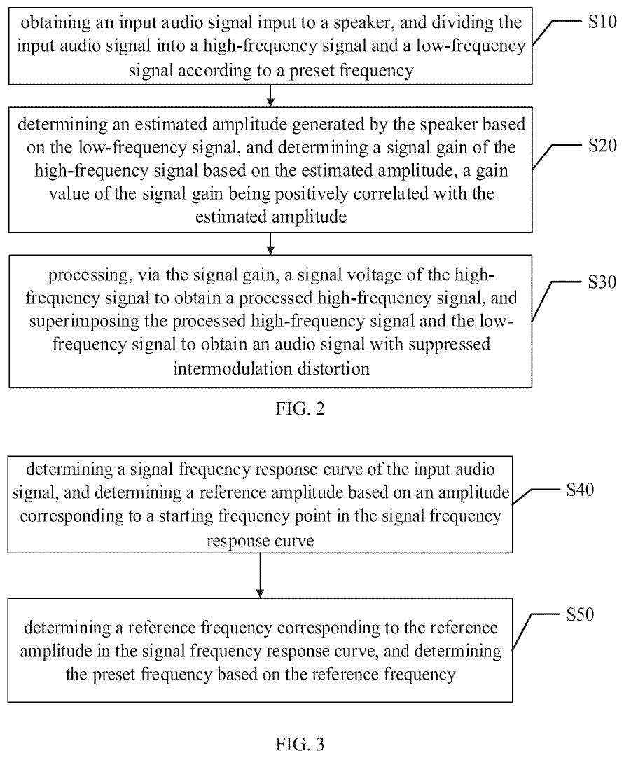

Further, as shown in FIG. 3, in an embodiment, before the step S10, the method further includes:

Step S40, determining a signal frequency response curve of the input audio signal, and determining a reference amplitude based on an amplitude corresponding to a starting frequency point in the signal frequency response curve.

In this embodiment, the signal frequency response curve of the input audio signal is determined, and the reference amplitude is determined based on the amplitude corresponding to the starting frequency point in the signal frequency response curve. In an embodiment, the reference amplitude value range can be determined based on the amplitude corresponding to the starting frequency point, and the reference amplitude is determined from the value range. In another embodiment, the correspondence between different amplitudes and the reference amplitude can be preset, and the reference amplitude corresponding to the amplitude of the starting frequency point can be determined from the correspondence, which is not limited here. For example, in an embodiment, the reference amplitude can be determined within the range of [X−6 db, X+6 db], and X is the amplitude corresponding to the starting frequency point.

Step S50, determining a reference frequency corresponding to the reference amplitude in the signal frequency response curve, and determining the preset frequency based on the reference frequency.

The reference frequency corresponding to the reference amplitude in the signal frequency response curve is determined, and the preset frequency is determined based on the reference frequency. In an embodiment, the reference frequency may be used as the preset frequency; in another embodiment, the reference frequency may be processed and the processed reference frequency may be used as the preset frequency.

In this embodiment, by determining the reference frequency based on the amplitude of the starting frequency point and determining the preset frequency based on the reference frequency, this embodiment can distinguish high-frequency signals and low-frequency signals according to the amplitude, so that large-amplitude signals are classified as low-frequency signals and small-amplitude signals are classified as high-frequency signals, thereby improving the intermodulation distortion suppression effect.

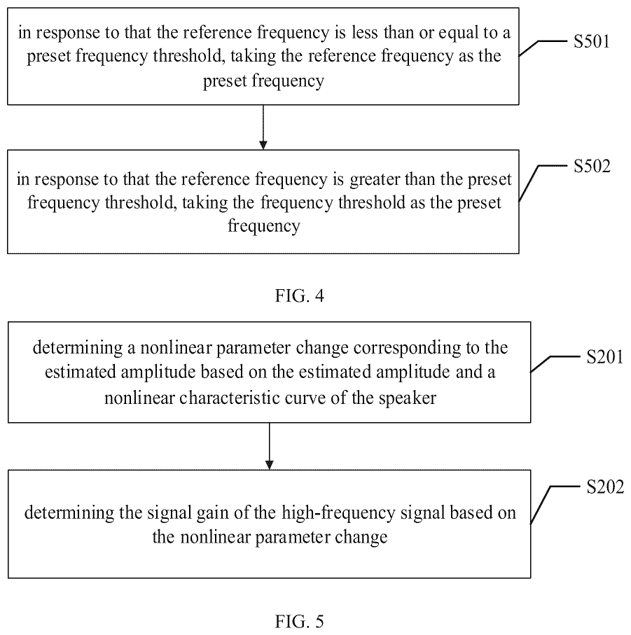

Further, as shown in FIG. 4, in another embodiment, the step S50 includes:

Step S501, in response to that the reference frequency is less than or equal to a preset frequency threshold, taking the reference frequency as the preset frequency.

In this embodiment, the frequency threshold is preset, and the preset threshold is determined based on the frequency threshold. The frequency threshold can be set according to actual needs. For example, in an embodiment, the frequency threshold can be set to 1 KHz. Based on the auditory characteristics of the human ear at different frequencies, the sound pressure level corresponding to 1 KHz is just the sound pressure level that the human ear can just hear. Therefore, using 1 KHz as the frequency threshold can make the preset frequency more accurate, thereby making the obtained high-frequency signal and low-frequency signal more accurate.

In an embodiment, detect whether the reference frequency is less than the frequency threshold. If the reference frequency is less than or equal to the preset frequency threshold, it is considered that the low-frequency signal is more accurately divided according to the reference frequency, that is, the low-frequency signal does not contain a high-frequency signal with a small amplitude, and the reference frequency is used as the preset frequency.

Step S502, in response to that the reference frequency is greater than the preset frequency threshold, taking the frequency threshold as the preset frequency.

If the reference frequency is greater than the frequency threshold, it is considered that the low-frequency signal divided according to the reference frequency may include a high-frequency signal. In order to ensure the accuracy of the low-frequency signal and the effect of suppressing intermodulation distortion, the frequency threshold is used as the preset frequency.

In this embodiment, the method includes: obtaining an input audio signal input to a speaker, and dividing the input audio signal into a high-frequency signal and a low-frequency signal according to a preset frequency; determining an estimated amplitude generated by the speaker based on the low-frequency signal, and determining a signal gain of the high-frequency signal based on the estimated amplitude, a gain value of the signal gain being positively correlated with the estimated amplitude; and processing, via the signal gain, a signal voltage of the high-frequency signal to obtain a processed high-frequency signal, and superimposing the processed high-frequency signal and the low-frequency signal to obtain an audio signal with suppressed intermodulation distortion.

The larger the estimated amplitude generated by the speaker based on the low-frequency signal, the larger the change in the nonlinear parameters in the speaker, resulting in a larger change in the Ampere driving force of the high-frequency signal. In this embodiment, the gain value of the signal gain is positively correlated with the estimated amplitude, the larger the estimated amplitude, the larger the signal gain value of the high-frequency signal, that is, the greater the adjustment degree of the signal voltage of the high-frequency signal, so that the change in the signal voltage of the high-frequency signal can offset the change in the Ampere driving force caused by the nonlinear parameters, so that the Ampere driving force of the high-frequency signal after processing under different estimated amplitudes remains stable, and the undesired envelope generated by the intermodulation of the low-frequency signal to the high-frequency signal is suppressed, thereby suppressing intermodulation distortion and improving the purity of the audio signal output by the speaker system.

Further, based on the above embodiment, the present application provides another embodiment of the signal processing method. In this embodiment, as shown in FIG. 5, the step S20 includes:

Step S201, determining a nonlinear parameter change corresponding to the estimated amplitude based on the estimated amplitude and a nonlinear characteristic curve of the speaker.

In this embodiment, the signal gain is determined based on the estimated amplitude and the nonlinear characteristic curve of the speaker to improve the accuracy of the signal gain.

In an embodiment, based on the estimated amplitude and the nonlinear characteristic curve of the speaker, the nonlinear parameter change corresponding to the estimated amplitude is determined. The intermodulation distortion is mainly affected by the nonlinear characteristics of the speaker: the electromechanical coefficient BL(x) and the inductance Le(x). Therefore, the nonlinear characteristic curve in this embodiment can be a BL(x) curve and/or a Le(x) curve, which is not limited herein.

From the nonlinear characteristic curve, the nonlinear parameter change corresponding to the estimated amplitude is determined, the nonlinear parameter change refers to the change of the nonlinear characteristic parameter that affects the intermodulation distortion, and the change is relative to the equilibrium position of the speaker voice coil, that is, the position where the displacement is 0.

In this embodiment, the process of determining the nonlinear parameter change corresponding to the estimated amplitude can be: determining the nonlinear parameter value corresponding to the estimated amplitude from the nonlinear characteristic curve (hereinafter referred to as the target parameter value for distinction); determining the nonlinear parameter value corresponding to the equilibrium position of the voice coil from the nonlinear characteristic curve (hereinafter referred to as the reference parameter value for distinction); calculating the nonlinear parameter change by subtracting the reference parameter value from the target parameter value.

Step S202, determining the signal gain of the high-frequency signal based on the nonlinear parameter change.

In this embodiment, the signal gain of the high-frequency signal is determined based on the nonlinear parameter change.

In an embodiment, the correspondence between different parameter changes and gains may be preset, and the gain corresponding to the nonlinear parameter change may be determined from the correspondence as the signal gain of the high-frequency signal. In another embodiment, the change rate of the target parameter value relative to the reference parameter value may be calculated based on the nonlinear parameter change, and the signal gain rate of the high-frequency signal may be determined based on the change rate, and the signal gain may be calculated based on the signal gain rate.

Further, in an embodiment, after obtaining the high-frequency signal, the signal gain can be adjusted based on the acoustic model and other characteristics of the speaker so that the adjusted signal gain is more consistent with the actual structure of the speaker. The high-frequency signal is processed by the adjusted signal gain to improve the effect of suppressing intermodulation distortion.

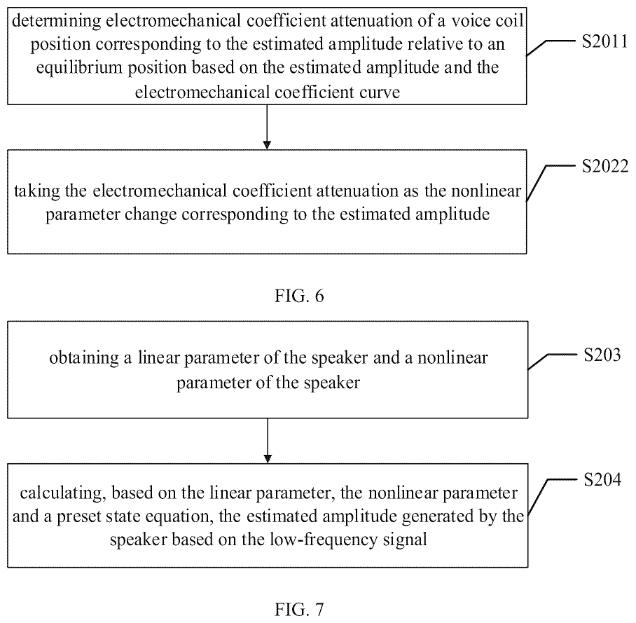

Further, as shown in FIG. 6, in an embodiment, the nonlinear characteristic curve includes an electromechanical coefficient curve, and the step S201 includes:

Step S2011, determining electromechanical coefficient attenuation of a voice coil position corresponding to the estimated amplitude relative to an equilibrium position based on the estimated amplitude and the electromechanical coefficient curve.

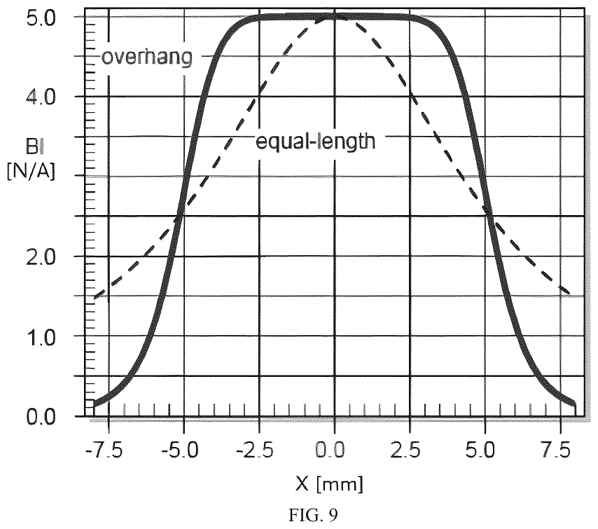

In this embodiment, as shown in FIG. 9, the horizontal axis X of FIG. 9 is the voice coil displacement, the absolute value of the voice coil displacement is the estimated amplitude, and the vertical axis is the BL electromechanical coefficient. The solid line curve is the BL change curve when the voice coil height is greater than the air gap depth (that is, the overhang shown in FIG. 9) for a long voice coil, and the dotted line curve is the BL change curve when the voice coil height is equal to the air gap depth (that is, the equal-length shown in FIG. 9). Referring to FIG. 9, it can be seen that whether the voice coil displacement is positive or negative, as the voice coil displacement value increases, the electromechanical coefficient is constantly decreasing, that is, as the estimated amplitude increases, the electromechanical coefficient is constantly attenuated.

Therefore, in this embodiment, based on the estimated amplitude and the electromechanical coefficient curve, the attenuation of the electromechanical coefficient of the voice coil position corresponding to the estimated amplitude relative to the equilibrium position is determined.

Step S2012, taking the electromechanical coefficient attenuation as the nonlinear parameter change corresponding to the estimated amplitude.

The attenuation of the electromechanical coefficient is taken as the nonlinear parameter change corresponding to the estimated amplitude. It should be noted that when the nonlinear characteristic curve includes the electromechanical coefficient curve, since the electromechanical coefficient is constantly attenuated as the estimated amplitude increases, the signal gain determined at this time should be constant and positive, that is, when considering the influence of the electromechanical coefficient on intermodulation distortion, the adjustment of the high-frequency signal should be gain adjustment.

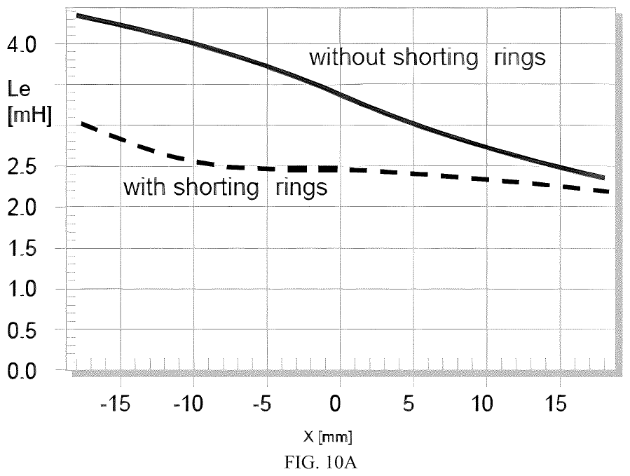

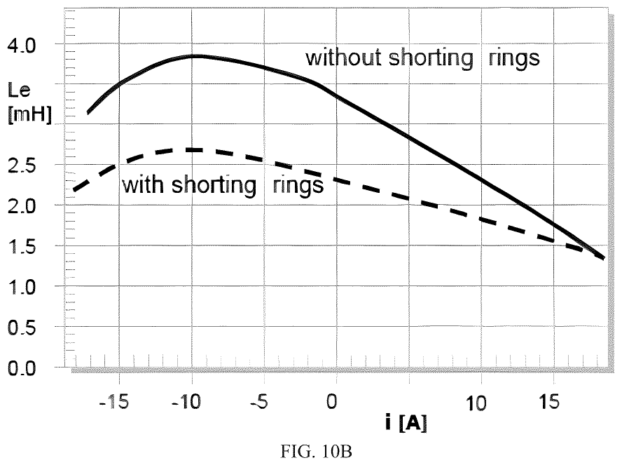

Further, in an embodiment, the nonlinear characteristic curve may also include an inductance curve. In this embodiment, the specific process of determining the nonlinear parameter change may be: based on the estimated amplitude and the inductance-displacement curve, determining the target inductance value corresponding to the voice coil displacement corresponding to the estimated amplitude; based on the target inductance value and the inductance-current curve, determining the target current value corresponding to the target inductance value; calculating the target current value minus the current value at the equilibrium position to obtain the inductance change; and taking the inductance change as the nonlinear parameter change. As shown in FIGS. 10A and 10B, the dashed curve in FIG. 10A represents the relationship curve between Le and X displacement when a shorting ring is installed (that is, with shorting rings as shown in FIG. 10A), and the solid curve in FIG. 10A represents the relationship curve between Le and X displacement when no shorting ring is installed (that is, without shorting rings as shown in FIG. 10A). Based on FIG. 10A and FIG. 10B, it can be seen that the inductance change may be positive or negative. Therefore, when considering the influence of inductance on intermodulation distortion, the adjustment of high-frequency signals may be gain adjustment or attenuation adjustment.

Further, in an embodiment, the nonlinear parameter change may be determined by combining the electromechanical coefficient and the inductance. For example, the product of the electromechanical coefficient attenuation and the inductance change may be used as the nonlinear parameter change. The specific setting may be based on actual needs and is not limited here.

Further, as shown in FIG. 7, in an embodiment, the step S20 includes:

Step S203, obtaining a linear parameter of the speaker and a nonlinear parameter of the speaker.

In this embodiment, the linear parameter and the nonlinear parameter in the loudspeaker are obtained.

The linear parameter is TS signal parameter, which may include: voice coil DC resistance Re, magnetic flux density B in the magnetic gap, length L of voice coil wire in the magnetic field, effective projection area Sd(=πa2) of diaphragm, and Pe(max), the maximum power rating determined by the heat dissipation capacity of the speaker unit, and Vd(=SdXmax), the volume pushed by the diaphragm at the maximum amplitude, where Sd is the diaphragm area and Xmax is the maximum amplitude. The nonlinear parameter may include: BL(x), Kms(x), Rms(v) and Le(x). Specifically, linear parameters and nonlinear parameters may be parameters preset in the speaker obtained during the R&D test phase. The preset parameters may reduce the amount of calculation and the delay of suppressing intermodulation distortion; they may also be parameters updated in real time based on the current and voltage signals generated by the speaker, which are not limited here.

Step S204, calculating, based on the linear parameter, the nonlinear parameter and a preset state equation, the estimated amplitude generated by the speaker based on the low-frequency signal.

The estimated amplitude generated by the speaker based on the low-frequency signal is calculated based on the linear parameter, the nonlinear parameter and the preset state equation.

The preset state equation is:

$$x ( t ) = {h}_{l} ( t ) * [ \frac{U ( t )}{α ( X )} - β ( X ) ]$$

hₗ(t) is the system response under the linear model of the loudspeaker, which can be calculated by linear parameters; U(t) is the input voltage, that is, the voltage of the low-frequency signal obtained after frequency division; α(x) and β(x) are the nonlinear state vectors of the loudspeaker, which can be calculated by nonlinear parameters such as BL(x), Kms(x), Rms(v) and Le(x).

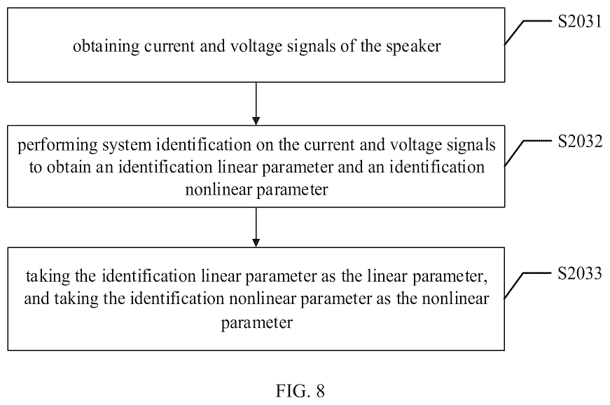

Further, as shown in FIG. 8, in an embodiment, the step S203 includes:

Step S2031, obtaining current and voltage signals of the speaker.

Because the system parameters of the speaker will change when it is in working state (especially in extreme state), for example, when working under high voltage, the temperature of the speaker will increase, which will cause the resistance to change, and the folding ring will become soft, causing the TS parameters to change. This change will cause the system parameters obtained in the pre-test to be no longer accurate, and there will be large errors in the amplitude prediction, which will reduce the quality of the high-frequency gain. Therefore, in this embodiment, by measuring the current and voltage signals at both ends of the speaker in real time, the speaker system parameters are optimized and updated through the speaker model to eliminate the errors introduced by the extreme operation of the speaker.

In this embodiment, the current and voltage signals of the speaker are obtained.

Step S2032, performing system identification on the current and voltage signals to obtain an identification linear parameter and an identification nonlinear parameter.

The system identification are performed on the current and voltage signals to obtain the identification linear parameter and the identification nonlinear parameter. The principle of system identification is to fit the electrical parameters of the speaker through the current and voltage signals, and update the parameters to minimize the error. It usually includes the following functional modules: a series resistor, a Pliot tone, an error calculation module and an optimization module. The current in the circuit is calculated by measuring the voltage across the series resistor to obtain the current and voltage signal. The Pliot tone is configured to add an extremely low-frequency small signal component to the signal. The error calculation module is configured to calculate the error between the predicted current and voltage signals and the measured current and voltage signals. The optimization module is configured to optimize the speaker system parameters to minimize the above error.

Step S2033, taking the identification linear parameter as the linear parameter, and taking the identification nonlinear parameter as the nonlinear parameter.

The identification linear parameter is taken as the linear parameter, and the identification nonlinear parameter is taken as the nonlinear parameter. Compared with using predicted linear parameter and nonlinear parameter, this embodiment can make the linear parameter and nonlinear parameter conform to the actual temperature and humidity, thereby improving the accuracy of the estimated amplitude.

In this embodiment, by determining the nonlinear parameter change corresponding to the estimated amplitude based on the estimated amplitude and the nonlinear characteristic curve of the loudspeaker, and determining the signal gain of the high-frequency signal based on the nonlinear parameter change, this embodiment improves the accuracy of the signal gain, thereby improving the effect of suppressing intermodulation distortion and improving the purity of the audio signal played by the loudspeaker.

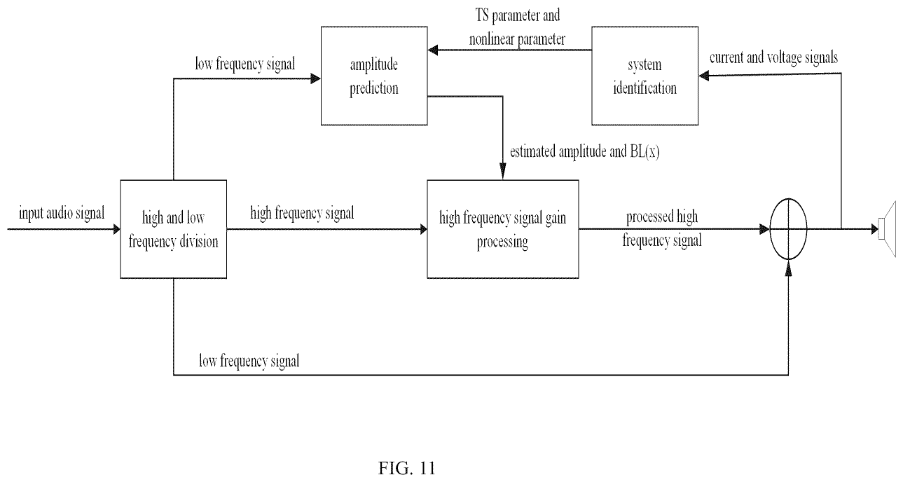

Further, in an embodiment, as shown in FIG. 11, the speaker in this embodiment is a micro speaker, and the signal processing process can be dividing the input audio signal into high and low frequencies.

The amplitude of the low-frequency signal is predicted based on the linear parameter (i.e., TS parameter) and the nonlinear parameter to obtain an estimated amplitude. Specifically, the linear parameter and the nonlinear parameter are obtained by system identification based on the current and voltage signals.

For micro speakers, since the inductance Le(x) is small, the intermodulation distortion is mainly caused by the magnetic field nonlinearity BL(x). Therefore, in this embodiment, the signal gain of the high-frequency signal gain processing is determined based on the estimated amplitude and BL(x), and the high-frequency signal is processed by the signal gain to obtain the processed high-frequency signal.

The processed high-frequency signal and the low-frequency signal are superimposed to obtain an audio signal with suppressed intermodulation distortion.

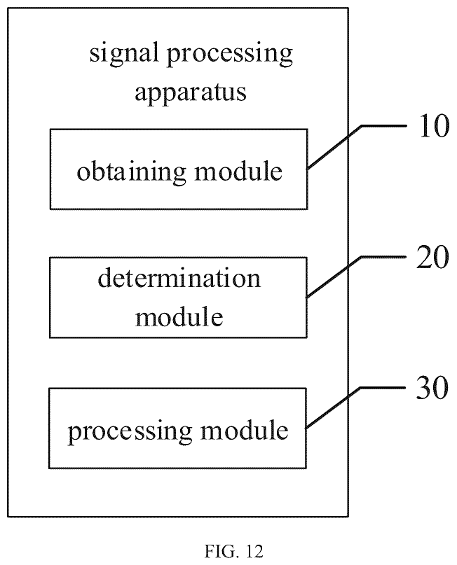

Besides, the present application further provides a signal processing apparatus. As shown in FIG. 12, the signal processing apparatus includes an obtaining module 10, a determination module 20 and a processing module 30.

The obtaining module 10 is configured for obtaining an input audio signal input to a speaker, and dividing the input audio signal into a high-frequency signal and a low-frequency signal according to a preset frequency.

The determination module 20 is configured for determining an estimated amplitude generated by the speaker based on the low-frequency signal, and determining a signal gain of the high-frequency signal based on the estimated amplitude, a gain value of the signal gain is positively correlated with the estimated amplitude.

The processing module 30 is configured for processing, via the signal gain, a signal voltage of the high-frequency signal to obtain a processed high-frequency signal, and superimposing the processed high-frequency signal and the low-frequency signal to obtain an audio signal with suppressed intermodulation distortion.

Further, the determination module 20 is further configured for:
determining a nonlinear parameter change corresponding to the estimated amplitude based on the estimated amplitude and a nonlinear characteristic curve of the speaker; and
determining the signal gain of the high-frequency signal based on the nonlinear parameter change.

Further, the nonlinear characteristic curve includes an electromechanical coefficient curve, and the determination module 20 is further configured for
determining electromechanical coefficient attenuation of a voice coil position corresponding to the estimated amplitude relative to an equilibrium position based on the estimated amplitude and the electromechanical coefficient curve; and
taking the electromechanical coefficient attenuation as the nonlinear parameter change corresponding to the estimated amplitude.

Further, the obtaining module 10 is further configured for:
obtaining a linear parameter of the speaker and a nonlinear parameter of the speaker; and
calculating, based on the linear parameter, the nonlinear parameter and a preset state equation, the estimated amplitude generated by the speaker based on the low-frequency signal.

Further, the obtaining module 10 is further configured for:
obtaining current and voltage signals of the speaker;
performing system identification on the current and voltage signals to obtain an identification linear parameter and an identification nonlinear parameter; and
taking the identification linear parameter as the linear parameter, and taking the identification nonlinear parameter as the nonlinear parameter.

Further, the determination module 20 is further configured for:
determining a signal frequency response curve of the input audio signal, and determining a reference amplitude based on an amplitude corresponding to a starting frequency point in the signal frequency response curve; and
determining a reference frequency corresponding to the reference amplitude in the signal frequency response curve, and determining the preset frequency based on the reference frequency.

Further, the determination module 20 is further configured for:
in response to that the reference frequency is less than or equal to a preset frequency threshold, taking the reference frequency as the preset frequency; or
in response to that the reference frequency is greater than the preset frequency threshold, taking the frequency threshold as the preset frequency.

The various embodiments of the signal processing apparatus of the present application may refer to the various embodiments of the signal processing method of the present application, which will not be described in detail here.

In addition, the present application further provides a computer-readable storage medium, on which a signal processing program is stored, and when the signal processing program is executed by a processor, the steps of the signal processing method described below are implemented.

The various embodiments of the signal processing device and computer-readable storage medium of the present application can refer to the various embodiments of the signal processing method of the present application, and will not be repeated here.

It should be noted that in this document, the terms “comprise”, “include” or any other variants thereof are intended to cover a non-exclusive inclusion. Thus, a process, method, article, or system that includes a series of elements not only includes those elements, but also includes other elements that are not explicitly listed, or also includes elements inherent to the process, method, article, or system. If there are no more restrictions, the element defined by the sentence “including a . . . ” does not exclude the existence of other identical elements in the process, method, article or system that includes the element.

The serial numbers of the foregoing embodiments of the present application are only for description, and do not represent the advantages and disadvantages of the embodiments.

Through the description of the above embodiment, those skilled in the art can clearly understand that the above-mentioned embodiments can be implemented by software plus a necessary general hardware platform, of course, it can also be implemented by hardware, but in many cases the former is a better implementation. Based on this understanding, the technical solution of the present application can be embodied in the form of software product in essence or the part that contributes to the existing technology. The computer software product is stored on a storage medium (such as ROM/RAM, magnetic disk, optical disk) as described above, including several instructions to cause a terminal device (which can be a mobile phone, a computer, a server, an air conditioner, or a network device, etc.) to execute the method described in each embodiment of the present application.

The above are only some embodiments of the present application, and do not limit the scope of the present application thereto. Under the concept of the present application, equivalent structural transformations made according to the description and drawings of the present application, or direct/indirect application in other related technical fields are included in the scope of the present application.

What is claimed is:

1. A signal processing method, comprising:
obtaining an input audio signal input to a speaker, and dividing the input audio signal into a high-frequency signal and a low-frequency signal according to a preset frequency;
determining an estimated amplitude generated by the speaker based on the low-frequency signal, and determining a signal gain of the high-frequency signal based on the estimated amplitude, wherein a gain value of the signal gain is positively correlated with the estimated amplitude; and
processing, via the signal gain, a signal voltage of the high-frequency signal to obtain a processed high-frequency signal, and superimposing the processed high-frequency signal and the low-frequency signal to obtain an audio signal with suppressed intermodulation distortion.

2. The signal processing method according to claim 1, wherein the determining the signal gain of the high-frequency signal based on the estimated amplitude comprises:
determining a nonlinear parameter change corresponding to the estimated amplitude based on the estimated amplitude and a nonlinear characteristic curve of the speaker; and
determining the signal gain of the high-frequency signal based on the nonlinear parameter change.

3. The signal processing method according to claim 2, wherein the nonlinear characteristic curve comprises an electromechanical coefficient curve, and
the determining the nonlinear parameter change corresponding to the estimated amplitude based on the estimated amplitude and the nonlinear characteristic curve of the speaker comprises:
determining electromechanical coefficient attenuation of a voice coil position corresponding to the estimated amplitude relative to an equilibrium position based on the estimated amplitude and the electromechanical coefficient curve; and
taking the electromechanical coefficient attenuation as the nonlinear parameter change corresponding to the estimated amplitude.

4. The signal processing method according to claim 1, wherein the determining the estimated amplitude generated by the speaker based on the low-frequency signal comprises:
obtaining a linear parameter of the speaker and a nonlinear parameter of the speaker; and
calculating, based on the linear parameter, the nonlinear parameter and a preset state equation, the estimated amplitude generated by the speaker based on the low-frequency signal.

5. The signal processing method according to claim 4, wherein the obtaining the linear parameter of the speaker and the nonlinear parameter of the speaker comprises:
obtaining current and voltage signals of the speaker;
performing system identification on the current and voltage signals to obtain an identification linear parameter and an identification nonlinear parameter; and
taking the identification linear parameter as the linear parameter, and taking the identification nonlinear parameter as the nonlinear parameter.

6. The signal processing method according to claim 1, wherein before the dividing the input audio signal into the high-frequency signal and the low-frequency signal according to the preset frequency, the method further comprises:
determining a signal frequency response curve of the input audio signal, and determining a reference amplitude based on an amplitude corresponding to a starting frequency point in the signal frequency response curve; and
determining a reference frequency corresponding to the reference amplitude in the signal frequency response curve, and determining the preset frequency based on the reference frequency.

7. The signal processing method according to claim 6, wherein the determining the preset frequency based on the reference frequency comprises:
in response to that the reference frequency is less than or equal to a preset frequency threshold, taking the reference frequency as the preset frequency; or
in response to that the reference frequency is greater than the preset frequency threshold, taking the frequency threshold as the preset frequency.

8. A signal processing apparatus, comprising:
an obtaining module, configured for obtaining an input audio signal input to a speaker, and dividing the input audio signal into a high-frequency signal and a low-frequency signal according to a preset frequency;
a determination module, configured for determining an estimated amplitude generated by the speaker based on the low-frequency signal, and determining a signal gain of the high-frequency signal based on the estimated amplitude, wherein a gain value of the signal gain is positively correlated with the estimated amplitude; and
a processing module, configured for processing, via the signal gain, a signal voltage of the high-frequency signal to obtain a processed high-frequency signal, and superimposing the processed high-frequency signal and the low-frequency signal to obtain an audio signal with suppressed intermodulation distortion.

9. A signal processing device, comprising: a memory, a processor, and a signal processing program stored in the memory and executable on the processor, wherein the signal processing program implements the signal processing method according to claim 1 when executed by the processor.

10. A non-transitory computer-readable storage medium, wherein a signal processing program is stored in the non-transitory computer-readable storage medium, and when the signal processing program is executed by a processor, the signal processing method according to claim 1 is implemented.
